(19) United States
(12) Patent Application Publication
(10) Pub. No.: US 2025/0215878 A1
(43) Pub. Date: Jul. 3, 2025

(54) WATER SUPPLIER FOR PETS

(71) Applicant: PurrSong, Inc., Daejeon (KR)

(72) Inventors: Tae Gu NOH, Suwon-si Gyeonggi-do (KR); Young Kyun KOH, Seoul (KR); Chang Hyeon BAK, Goyang-si Gyeonggi-do (KR)

(73) Assignee: PurrSong, Inc., Daejeon (KR)

(21) Appl. No.: 18/773,659

(22) Filed: Jul. 16, 2024

(30) Foreign Application Priority Data
Jan. 3, 2024 (KR) 10-2024-0001099

(51) Int. Cl. F04D 13/02; A01K 7/02; F04D 29/22

(52) U.S. Cl. CPC F04D 13/024; F04D 29/22; A01K 7/02

(57) ABSTRACT

A water supplier according to an embodiment of the present invention includes a casing including a water intake port and a supply unit disposed in the casing, wherein the supply unit includes a rotor disposed in a storage space which accommodates fluid inside the casing, and a stator disposed in a control space isolated from the storage space inside the casing and configured to transmit electromagnetic force to drive the rotor, and the rotor includes a body portion configured to guide the fluid, a first magnetic member disposed in the body portion, and a second magnetic member fixed to the body portion by the first magnetic member and configured to receive the electromagnetic force from the stator.

### CROSS-REFERENCE TO RELATED APPLICATION

This application claims the benefit under 35 USC 119 (a) of Korean Patent Applications No. 10-2024-0001099 filed on Jan. 3, 2024 in the Korean Intellectual Property Office, the entire disclosures of which are incorporated herein by reference for all purposes.

### TECHNICAL FIELD

The present disclosure relates to a water supplier for pets.

### BACKGROUND

Water purifiers are designed to purify water by removing impurities from water by physical and chemical methods. A water purifier needs to be designed to maintain filter performance and keep the inside clean.

In recent years, pets have been regarded as a part of the family and various specialized products for pets have been designed. A water purifier or water supplier can serve to provide drinkable water to pets. The water purifier or water supplier for pets needs to provide clean water to pets even when the owner is away.

The water purifier or water supplier for pets needs to be designed to keep the inside clean and facilitate follow-up management. In this regard, Korean Patent No. 2057934 discloses an animal water purifier using wireless power. The animal water purifier disclosed in this publication includes a water purification container, a water purification module built into the water purification container, and a bowl for supplying water. Further, the water purification module is configured as a single module in which a water purification filter and a pump driving unit are combined.

Meanwhile, in the above-described animal water purifier of Korean Patent No. 2057934, a wireless power receiver, a controller, and a motor integrated with a pump are configured as a single module and then coupled to the water purification filter. The water purification filter coupled to a control module is built in the water purification module. Since the water purification module into which the water purification filter and the control module are built is mounted in a water accommodation space, the control module is also mounted in the water accommodation space.

Since the control module, which is built in the water purification module, is mounted in the water accommodation space, it is not directly exposed to water. However, since the control module and the water purification module are mounted together in the water accommodation space, there is a possibility of being exposed to water. Therefore, the animal water purifier according to the prior art has a problem in that the control module may be degraded in performance when used for a long time.

Meanwhile, if a space or a component for accommodating water inside a water purifier or water supplier has a complicated shape or elaborate shape, it may be difficult for a user to perform maintenance, such as cleaning scales. Also, a material of a component in contact with water for a long time or an adhesive material needs to be designed in consideration of the hygiene and health of pets.

### PRIOR ART DOCUMENT

### Patent Document

(Patent Document 1) Korean Patent No. 10-2057934 B1 (registered on Dec. 16, 2019)

### SUMMARY

In view of the foregoing, the present disclosure is conceived to provide a water supplier for pets in which a component in contact with water for drinking has a simple shape and is formed of a hygienic material.

Also, the present disclosure is conceived to provide a water supplier for pets in which components are formed and coupled to facilitate cleaning and maintenance by the user.

However, the problems to be solved by the present disclosure are not limited to the above-described problems. There may be other problems to be solved by the present disclosure.

As a means to achieve the above-described technical problem, a water supplier according to an embodiment of the present invention may include a casing including a water intake port and a supply unit disposed in the casing, wherein the supply unit includes a rotor disposed in a storage space which accommodates fluid inside the casing, and a stator disposed in a control space isolated from the storage space inside the casing and configured to transmit electromagnetic force to drive the rotor, and the rotor includes a body portion configured to guide the fluid, a first magnetic member disposed in the body portion, and a second magnetic member fixed to the body portion by the first magnetic member and configured to receive the electromagnetic force from the stator.

A drive unit for the water supplier disposed in the water supplier to form a flow for supplying fluid may include a rotor rotatably disposed in a storage space in which the fluid is accommodated inside the water supplier, and a stator disposed in a control space isolated from the storage space inside the water supplier and configured to transmit electromagnetic force to drive the rotor, wherein the rotor includes a body portion configured to guide the fluid, a first magnetic member disposed in the body portion, and a second magnetic member fixed to the body portion by the first magnetic member and configured to receive the electromagnetic force from the stator.

The above-described means for solving the problem are merely illustrative and should not be construed as limiting the present invention. In addition to the exemplary embodiments described above, there may be additional embodiments described in the drawings and detailed description of the invention.

According to an embodiment of the present disclosure, a rotor can be fabricated by molding a body portion with a first magnetic member inserted thereinto and magnetically coupling a second magnetic member to the body portion by the first magnetic member.

Therefore, a blade shape can be formed by injection molding in a high temperature environment and a magnetic rotor can be fabricated without adhesive. The rotor can be used safely and hygienically in a space in which drinkable water is accommodated without worrying about hazardous materials, such as adhesive components.

Also, according to an embodiment of the present disclosure, a water tank and the rotor provided in a water supplier can be easily disassembled by the user, and have an uncomplicated shape. Thus, it is easy to perform maintenance and cleaning of the water supplier, and the water supplier can be used hygienically.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different figures indicates similar or identical items.

FIG. 1 is a perspective view of a water supplier according to an embodiment of the present disclosure.

FIG. 2 is a longitudinal cross-sectional view of the water supplier shown in FIG. 1.

FIG. 3 is an enlarged view of an area A shown in FIG. 2.

FIG. 4 is provided to explain the flow of fluid inside the water supplier according to an embodiment of the present disclosure.

FIG. 5 is a cross-sectional view illustrating a part of a supply unit and a water tank of the water supplier according to another embodiment of the present disclosure.

FIG. 6A shows perspective views of a rotor of the water supplier according to an embodiment and another embodiment of the present disclosure.

FIG. 6B shows other perspective views of the rotor of the water supplier according to an embodiment and another embodiment of the present disclosure.

FIG. 6C shows cross-sectional views of the rotor of the water supplier according to an embodiment and another embodiment of the present disclosure.

FIG. 7 shows perspective views of a stator of the water supplier according to an embodiment and another embodiment of the present disclosure.

FIG. 8 shows perspective views of a frame of the water supplier according to an embodiment and another embodiment of the present disclosure.

### DETAILED DESCRIPTION

Hereinafter, embodiments of the present disclosure will be described in detail with reference to the accompanying drawings to be readily implemented by a person with ordinary skill in the art to which the present disclosure belongs. However, it is to be noted that the present disclosure is not limited to the example embodiments but can be embodied in various other ways. In the drawings, parts irrelevant to the description are omitted in order to clearly explain the present disclosure, and like reference numerals denote like parts through the whole document.

Through the whole document, when a part is referred to as being “connected” to another part, this includes not only “directly connected” but also cases where other components are interposed, or where they are “electrically connected” with other elements in between. Additionally, when a part is said to “include” a certain component, it means that, unless specifically stated otherwise, it can include other components as well, and should be understood to not preclude the presence or addition of one or more other features, numbers, steps, actions, components, parts, or combinations thereof.

Some of the operations or functions described as being performed by the device in this specification may instead be performed by a server, terminal, or device connected to the device.

Hereinafter, the present invention will be described in detail with reference to the attached drawings, which illustrate an embodiment of the invention.

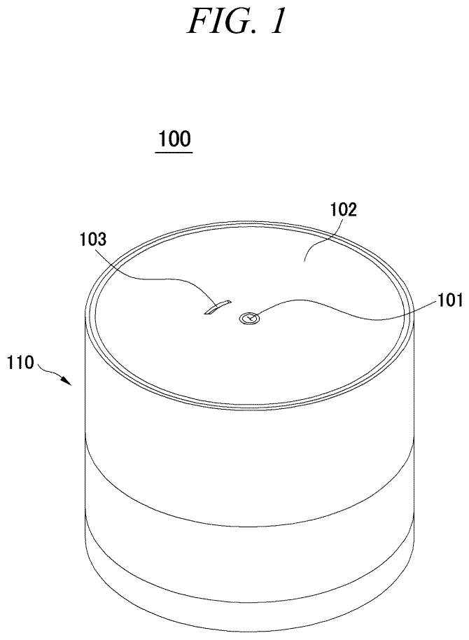

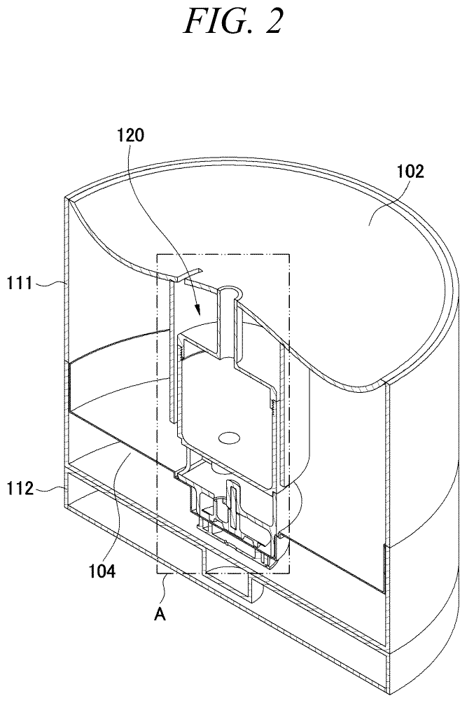

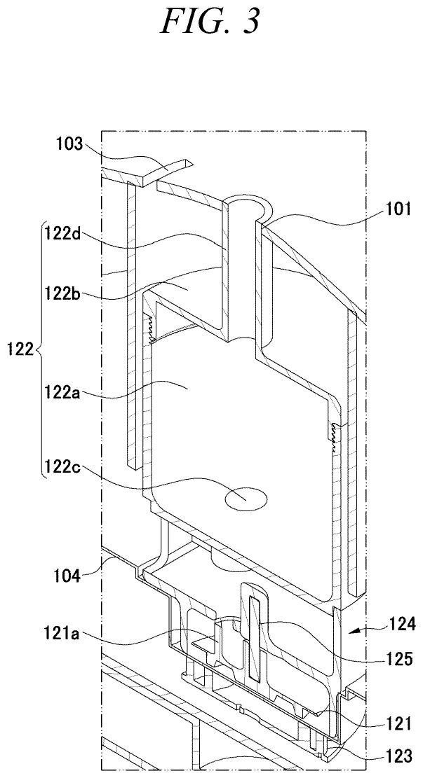

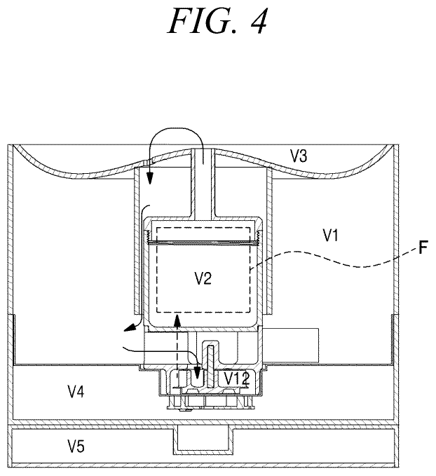

FIG. 1 is a perspective view of a water supplier 100 according to an embodiment of the present disclosure, and FIG. 2 is a longitudinal cross-sectional view of the water supplier 100 shown in FIG. 1. FIG. 3 is an enlarged view of an area A shown in FIG. 2. FIG. 4 is provided to explain the flow of fluid inside the water supplier 100 according to an embodiment of the present disclosure.

The water supplier 100 according to the present disclosure is a device configured to circulate water and render it drinkable, and may include a water purifier that filters raw water and provides purified water. In the water supplier 100 according to an embodiment of the present disclosure, a storage space for accommodating and purifying water is divided from a control space for providing and controlling power for driving fluid in the storage space. Thus, the performance of a controller can be maintained even when the water supplier 100 is used for a long time, and the fluid in the storage space can be maintained clean without a contact with the controller.

Also, the water supplier 100 can be easily disassembled and assembled so that respective spaces divided according to functions can be cleaned and managed individually. Thus, it is easy to perform maintenance.

Referring to FIG. 1 and FIG. 2, the water supplier 100 according to an embodiment of the present disclosure may include a casing 110 and a supply unit 120 disposed in the casing 110. The casing 110 may include a water intake port 101. Further, referring to FIG. 3, the supply unit 120 may include a rotor 121, a filter unit 122, a stator 123, a frame 124, and a rotary pin 125. However, if purified or drinkable water is supplied from the outside to the water supplier 100 according to the present disclosure, the supply unit 120 may not be equipped with the filter unit 122.

The casing 110 may be designed in a cylindrical shape as shown in FIG. 1. The casing 110 can be implemented in many different forms and is not limited to the embodiments described herein. The casing 110 may accommodate therein a fluid including water and the supply unit 120 for moving the fluid.

Referring to FIG. 1, the casing 110 according to an embodiment of the present disclosure may further include a water intake container 102 and a water recovery port 103. For example, the water intake container 102 may include a concave accommodation space at an upper portion to accommodate a predetermined amount of fluid. The water intake container 102 may be coupled to an upper portion of a main body case 111 and may accommodate the fluid discharged from the supply unit 120 while exposing the fluid upwards. For example, when the fluid purified through the supply unit 120 is discharged to the outside through the water intake port 101, the water intake container 102 may accommodate a predetermined amount of the discharged fluid.

The upper portion of the main body case 111 may be closed by the water intake container 102, and a water intake plate (not shown) may be further disposed at the upper portion of the water intake container 102. The water intake plate may be configured to allow the fluid discharged from the water intake port 101 to naturally flow.

The water intake container 102 capable of accommodating a predetermined amount of fluid may move some of the fluid discharged from the water intake port 101 back to the storage space through the water recovery port 103. The water recovery port 103 may be formed through the water intake container 102 so that the fluid in a water intake space can be dropped into and recovered in the storage space.

The water recovery port 103 is a hole formed on one side of the water intake container, and enables communication between an external space and an internal space of the casing 110. Therefore, some of the fluid accommodated in the water intake container 102 is recovered back in the storage space through the water recovery port 103. Thus, the water intake container 102 can accommodate a predetermined amount of fluid and suppress the overflow of purified water from the water intake container 102. Herein, the water recovery port 103 can be implemented in many different forms at different radial locations (certain points between the center and edges) and is not limited to the embodiment shown in FIG. 1. Also, a plurality of water recovery ports 103 may be formed in various directions of the water intake container 102.

Referring to FIG. 2, the casing 110 may include the main body case 111.

The main body case 111 may form a storage space V1 for accommodating raw water. For example, a user may put raw water into the main body case 111 and then mount the main body case 111 in the water supplier 100 according to the present disclosure.

The casing 110 may further include a sub-case 112. The sub-case 112 may be coupled to a lower portion of the main body case 111 and may further form therein an additional space V5. The sub-case 112 and the additional space V5 may form the water supplier 100 according to the present disclosure at a predetermined height or provide a space for accommodating some components of the water supplier 100 according to the present disclosure.

Referring to FIG. 2 and FIG. 4, the main body case 111 may be equipped with a partition wall 104 to divide the inside into the storage space V1 and a control space V4. The partition wall 104 may divide an internal space of the main body case 111 into the storage space V1 and the control space V4. For example, the internal space of the main body case 111 may be divided into upper and lower parts by the partition wall 104, and the upper part or the inside of the main body case 111 divided by the partition wall 104 may serve as the storage space V1 and the lower part or the outside of the main body case 111 may serve as the control space V4. That is, the storage space V1 may be configured to accommodate fluid, and the control space V4 may be configured not to accommodate fluid.

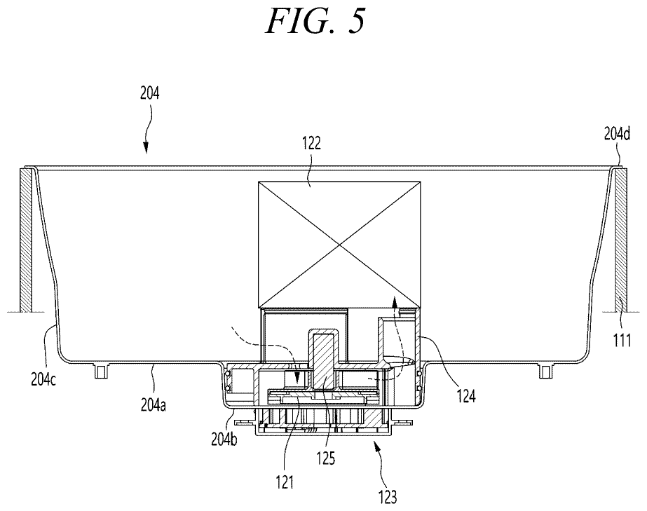

FIG. 5 is a cross-sectional view illustrating a part of the supply unit 120 and the water tank 204 of the water supplier 100 according to another embodiment of the present disclosure. In another embodiment of the present disclosure, the water tank 204 instead of the partition wall 104 described above may be detachably mounted in the main body case 111 as shown in FIG. 5. If the water tank 204 is detachably coupled to the upper portion of the main body case 111 as in another embodiment of the present disclosure, the user may separate the water tank 204 from the main body case 111 and wash only the water tank 204. Also, the user may put raw water or drinkable water into the water tank 204 and then mount the water tank 204 in the water supplier 100.

Specifically, the water tank 204 may form a storage space and accommodate the rotor 121 and the filter unit 122. The water tank 204 may include a base portion 204a, a rotor accommodation groove 204b, a sidewall portion 204c, and a support portion 204d.

As shown in FIG. 5, the base portion 204a may be a substantially flat annular plate. The rotor accommodation groove 204b may extend downwards from the center of the base portion 204a and accommodate a rotor. The sidewall portion 204c may extend from the end of the base portion 204a upwards to a height at which at least a part of the supply unit 120 is immersed in the fluid (raw water, purified water, or drinkable water) accommodated therein. Also, the support portion 204d may extend from an upper end of the sidewall portion 204c in a radial direction and may be supported by the main body case 111 from below.

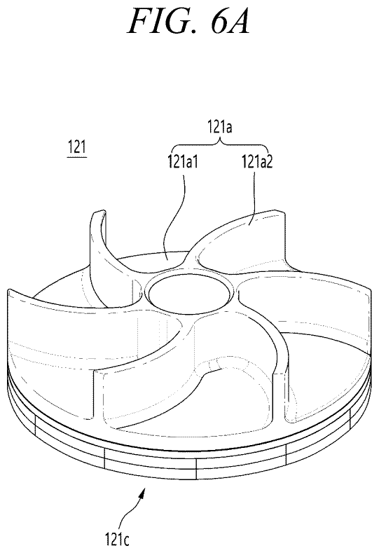

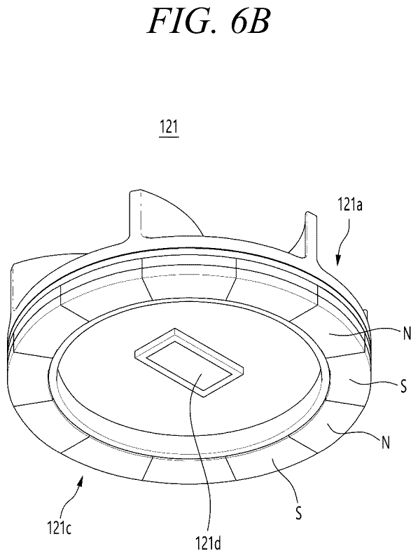

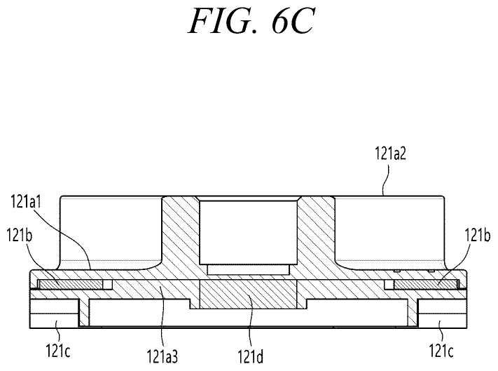

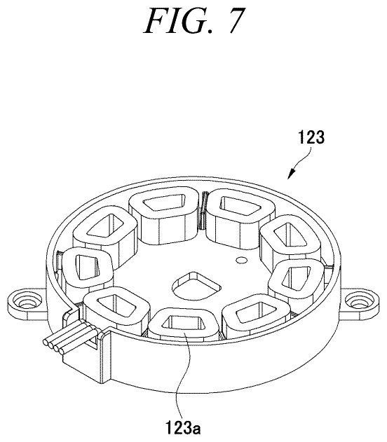

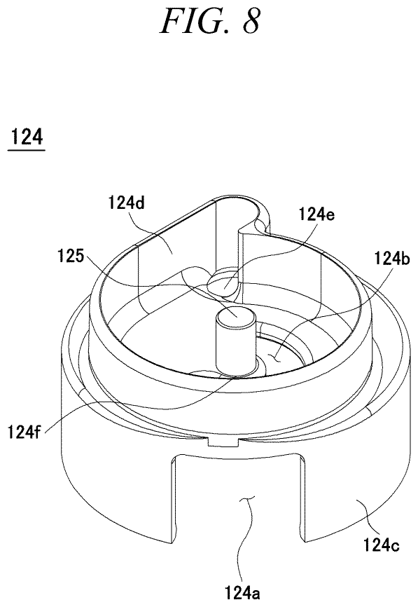

FIG. 6A shows perspective views of the rotor 121 of the water supplier 100 according to an embodiment and another embodiment of the present disclosure, FIG. 6B shows other perspective views of the rotor 121 of the water supplier 100 according to an embodiment and another embodiment of the present disclosure, and FIG. 6C shows cross-sectional views of the rotor 121 of the water supplier 100 according to an embodiment and another embodiment of the present disclosure. FIG. 7 shows perspective views of the stator 123 of the water supplier 100 according to an embodiment and another embodiment of the present disclosure, and FIG. 8 shows perspective views of the frame 124 of the water supplier 100 according to an embodiment and another embodiment of the present disclosure.

Referring to the drawings, the rotor 121 may be rotatably disposed in the storage space V1 in which the fluid inside the water supplier 100 flows. The fluid in the storage space V1 may be supplied to the supply unit 120 to be described later as the rotor 121 rotates.

The rotor 121 may have a hole in the center. The rotary pin 125 of the frame 124 can be inserted into the hole. A bushing or bearing may be coupled to an inner surface of the hole. Therefore, it is possible to suppress abrasion of the inner surface when the rotor 121 rotates.

Referring to FIG. 6A to FIG. 6C, the rotor 121 may include a body portion 121a, a first magnetic member 121b, a second magnetic member 121c, and a third magnetic member 121d. The body portion 121a may include flange portions 121a1 and 121a3, and a blade portion 121a2 extending from one side of the flange portions 121a1 and 121a3 in order to guide the fluid by rotation.

The first magnetic member 121b may be disposed inside the body portion 121a. For example, the first magnetic member 121b may be disposed inside the flange portions 121a1 and 121a3. The flange portions 121a1 and 121a3 may be formed to surround the first magnetic member 121b. The body portion 121a or the flange portions 121a1 and 121a3 may be formed to surround entire surface of the first magnetic member 121b.

In the present embodiments, the second magnetic member 121c may be fixed to the body portion 121a by the first magnetic member 121b. That is, the second magnetic member 121c may be coupled to the first magnetic member 121b via the body portion 121a through magnetic force. Further, the second magnetic member 121c may be configured to receive electromagnetic force from the stator 123. The second magnetic member 121c may form a brushless direct current (BLDC) motor together with the stator 123 as will be described later. Meanwhile, the third magnetic member 121d may be disposed under the flange portion 121a1 to provide magnetic force as the coupling force between the rotary pin 125 and the rotor 121.

The first magnetic member 121b may be formed of a magnetic metal material, such as iron. The first magnetic member 121b may extend along a circumferential direction of the rotor. In particular, the body portion 121a may be formed of a plastic material to surround the first magnetic member 121b by injection molding (insert injection molding) in a state where the first magnetic member 121b is located inside a die.

That is, the flange portion 121a1 illustrated as being on the first magnetic member 121b and the flange portion 121a3 illustrated as being under the first magnetic member 121b in FIG. 6A to FIG. 6C may be formed as one body by injection molding.

When the body portion 121a is fabricated by typical injection molding, the body portion 121a may lose magnetism during a high-temperature molding process even if a magnetic member is inserted in the body portion 121a. Therefore, the body portion 121a may be fabricated to have magnetism by insert injection molding for inserting the first magnetic member 121b, such as a metal, having magnetism as in the present embodiments. That is, the first magnetic member 121b may be formed of a magnetic material which can provide sufficient magnetic force, and the body portion 121a may be formed of a plastic material which is harmless to humans or animals.

The second magnetic member 121c may be attached to the other side of the flange portion 121a1. The second magnetic member 121c may be made of a permanent magnetic material, and may extend along the circumferential direction of the rotor. The second magnetic member 121c may be formed along the circumferential direction so that different poles (N-pole and S-pole) alternate with each other. Also, the second magnetic member 121c may be composed of two or more layers so that different poles alternate with each other in a vertical direction.

The second magnetic member 121c may be coupled to the body portion 121a in which the first magnetic member 121b is inserted so that the second magnetic member 121c is fixed to the body portion 121a through magnetic force. Therefore, adhesive components, which are likely to be dissolved in water, may not be used when the second magnetic member 121c is coupled to the body portion 121a. The second magnetic member 121c is formed along the circumferential direction so that the N-pole and S-pole alternate with each other. Thus, the rotation efficiency may be improved by transmission of electromagnetic force from the stator 123.

Referring to FIG. 7, the stator 123 may be configured to drive the rotor 121. The stator 123 may be disposed in the control space isolated from the storage space inside the casing 110, and configured to transmit electromagnetic force to the second magnetic member 121c of the rotor 121 and drive the rotor 121 to rotate. For example, the stator 123 may include a plurality of coils 123a at its edge. The second magnetic member 121c of the rotor 121 and the stator 123 according to the embodiments of the present disclosure may be configured as a BLDC motor.

The rotor 121 and the stator 123 according to the embodiments of the present disclosure may be located corresponding to each other with the partition wall 104 or the water tank 204 interposed therebetween. The rotor 121 may be disposed in the storage space V1, and the stator 123 may be disposed in the control space V4.

In this way, the storage space V1 and the control space V4 are divided by the partition wall 104 or the water tank 204, and the rotor 121 may be located in the storage space V1 in which fluid flows or is stored to directly guide the flow of the fluid and a battery for supplying power to the water supplier 100 and the controller for controlling the operation speed and time of the rotor 121 may be located in the control space V4 in which fluid is not accommodated.

Referring to FIG. 2, the supply unit 120 according to the embodiments of the present disclosure may be mounted in a central portion of the main body case 111. The filter unit 122 of the supply unit 120 may communicate with the storage space V1 and may be configured to filter the fluid supplied by the rotor 121 and discharge the filtered fluid. The filter unit 122 may be disposed in the water tank 204 and at an upper portion of the frame 124.

FIG. 8 illustrates the inverted frame 124 according to the embodiments of the present disclosure. The frame 124 may include a main housing 124c, a rotor housing 124d, and a discharge housing 124e. Communication holes 124a and 124b may be formed in the main housing 124c. As shown in FIG. 8, the first communication hole 124a formed in the main housing 124c enables communication between an external space and an internal space of the frame 124, and the second communication hole 124b enables communication between an internal space of the main housing 124c and an internal space of the rotor housing 124d.

The rotor housing 124d may be connected to the main housing 124c and may accommodate the rotor 121, and the discharge housing 124e may guide the fluid discharged from the rotor housing 124d to the filter unit 122. For example, the fluid accommodated in the storage space V1 may flow into the internal space of the frame 124 through the first communication hole 124a formed in the frame 124, and the fluid accommodated in the internal space may flow through the second communication hole 124b into the space in which the rotor 121 is disposed and the rotor 121 may guide the fluid to the filter unit 122.

When the rotary pin 125 is inserted into each of to the rotor 121 and the frame 124, the rotor 121 can be stably mounted in the frame 124. The rotary pin 125 is designed in a cylindrical shape. Thus, the rotary pin 125 can be inserted into a central portion of the rotor 121 and can also support the rotor 121 to be rotatable.

Referring to FIG. 4, the frame 124 may support the filter unit 122 and form a pumping area V12 which is a part of the storage space V1. The pumping area V12 may be formed at a bottom portion of the storage space V1. Specifically, the pumping area V12 is a space formed by the rotor accommodation groove 204b and the rotor housing 124d. Thus, as the rotor 121 rotates, the fluid accommodated in the storage space V1 may be pumped through the pumping area V12 and may flow into the filter unit 122.

Referring back to FIG. 3 and FIG. 4, the filter unit 122 according to an embodiment of the present disclosure may include a filter body F, a filter accommodation unit 122a, and a cover unit 122b. The cover unit 122b may be detachably coupled to the filter accommodation unit 122a, and the filter accommodation unit 122a may be formed into a cylindrical shape to accommodate the filter body F. Fluid to be supplied may pass through the filter body F. For example, the filter body F may purify fluid that has moved to the filter unit 122 in the storage space as the rotor 121 rotates.

The filter accommodation unit 122a and the cover unit 122b may form a filter space V2 of which one side communicates with the pumping area V12 and the other side communicates with a water intake space V3.

Specifically, the filter unit 122 may further include an inlet tube 122c and an outlet tube 122d. The inlet tube 122c may extend from the filter accommodation unit 122a to enable communication between the filter space V2 in which the filter body F is accommodated and the storage space V1. For example, the inlet tube 122c may be formed under the filter unit 122 at a position corresponding to the discharge housing 124e of the frame 124. The inlet tube 122c may guide, to the filter unit 122, the fluid discharged to the discharge housing 124e through the communication holes 124a and 124b of the frame 124 as the rotor 121 rotates.

The outlet tube 122d may extend from the cover unit 122b to be connected to the water intake port 101. For example, when the water intake container 102 is mounted at an upper portion of the water supplier 100, the outlet tube 122d may be located to be inserted into the water intake port 101.

The outlet tube 122d extending upwards toward the water intake port 101 from the cover unit 122b may be accommodated in the filter body F and may discharge the purified fluid to the outside through the water intake port 101 as the rotor 121 rotates.

Referring to the flow of the fluid accommodated in the water supplier 100 illustrated in FIG. 4, the fluid supplied into the water supplier 100 may be accommodated and stored in the storage space V1 configured to accommodate raw water and formed by the main body case 111.

The fluid in the storage space V1 may be supplied into the filter space V2 via the pumping area V12. Specifically, the fluid accommodated in the storage space V1 may be accommodated in the pumping area V12 as the rotor 121 rotates. The fluid flowing into the pumping area V12 as the rotor 121 rotates may be guided by the frame 124 to the filter space V2 formed in the filter unit 122 via the inlet tube 122c.

The fluid purified through the filter space V2 may be discharged to and accommodated in the water intake space V3 formed by the water intake container 102. Specifically, the fluid accommodated in the filter space V2 may be filtered and then discharged to the water intake space V3 through the water intake port 101 along the outlet tube 122d. At least some of the fluid in the water intake space V3 may be recovered in the storage space V1. Since the water intake space V3 can accommodate only a predetermined amount of fluid, some of the fluid accommodated in the water intake space V3 may be accommodated again in the storage space V1 through the water recovery port 103.

The fluid accommodated in the storage space V1 may flow again into the supply unit 120 as the rotor 121 rotates, and may undergo a purification process. Then, the fluid may be discharged to the water intake space V3.

In the water supplier 100 according to the embodiments of the present disclosure, the rotor 121 disposed in the storage space V1 is fabricated to be magnetic without using a hazardous material, such as adhesive, and, thus, it is possible to eliminate the concern about contamination of drinkable water by the rotor 121. Also, the stator 123 and a power source means may be disposed in the control space V4 isolated from the storage space V1, and, thus, it is possible to secure the reliability of the performance.

In addition to the material of the rotor 121, the water supplier 100 according to the embodiments of the present disclosure has advantages, such as easiness in using, disassembling and washing the components disposed in the storage space V1. The water tank 204 may be separated from the water supplier 100, and, thus, it is possible to easily wash the insides of the base portion 204a and the rotor accommodation groove 204b each having a flat bottom. That is, a portion where it is highly possible that scales are caused by residue of drinkable water has a simple shape, and, thus, it is easy to wash the water supplier 100.

Also, the water tank 204 filled with raw water or drinkable water is mounted in the water supplier 100, and, thus, it is possible to refill the water supplier 100 with water in a state where the main body case 111 and the like are not in contact with water.

In the water supplier 100 according to the embodiments of the present disclosure, the control space V4, the storage space V1, and the water intake space V3 are formed in sequence from bottom to top, and, thus, the spaces and components with high frequency of maintenance, such as washing or component replacement are disposed in sequence at an upper portion. Therefore, it is intuitive and easy for the user to use and perform maintenance. Also, the filter unit 122 disposed at a central portion of the main body case 111 can be separated to regularly replace or wash the filter body F. Further, the frame 124 and the rotor 121 disposed at a lower portion of the filter unit 122 can be separated for washing or cleaning based on the maintenance cycle.

Meanwhile, a driving unit for a water supplier is disposed in the water supplier 100 according to the embodiments of the present disclosure and configured to form a flow for supplying the fluid may include the rotor 121 and the stator 123. The rotor 121 may be rotatably disposed in the storage space in which fluid is accommodated inside the water supplier. The stator 123 may be disposed in the control space isolated from the storage space inside the water supplier and configured to transmit electromagnetic force to the rotor 121 and drive the rotor 121 to rotate. Herein, the rotor 121 may include the body portion 121a configured to guide the fluid, the first magnetic member 121b disposed in the body portion 121a, and the second magnetic member 121c fixed to the body portion 121a by the first magnetic member 121b and configured to receive electromagnetic force from the stator 123.

The foregoing description of the present invention is for illustrative purposes, and it will be understood by those skilled in the art to which this invention pertains that various modifications can be made without departing from the spirit or essential characteristics of the present invention. Therefore, the embodiments described above are to be considered in all respects as illustrative and not restrictive. For example, each component described as a single entity may be implemented in a distributed manner, and likewise, components described as distributed may be implemented in a combined form.

The scope of the present invention is indicated by the claims below rather than by the detailed description above, and all changes or modifications derived from the meaning and scope of the claims and their equivalents are to be interpreted as being included within the scope of the present invention.

We claim:

1. A water supplier, comprising:
a casing including a water intake port; and
a supply unit disposed in the casing,
wherein the supply unit includes:
a rotor disposed in a storage space which accommodates fluid inside the casing; and
a stator disposed in a control space isolated from the storage space inside the casing and configured to transmit electromagnetic force to drive the rotor, and
the rotor includes:
a body portion configured to guide the fluid;
a first magnetic member disposed in the body portion; and
a second magnetic member fixed to the body portion by the first magnetic member and configured to receive the electromagnetic force from the stator.

2. The water supplier of claim 1,
wherein the body portion is formed to surround entire surface of the first magnetic member, and
the second magnetic member is coupled to the first magnetic member via the body portion through magnetic force.

3. The water supplier of claim 1,
wherein the body portion includes:
a flange portion formed to surround the first magnetic member; and
a blade portion extending from one side of the flange portion and configured to guide the fluid by rotation, and
the second magnetic member is attached to the other side of the flange portion.

4. The water supplier of claim 3,
wherein at least one of the first magnetic member and the second magnetic member extends along a circumferential direction of the rotor.

5. The water supplier of claim 1,
wherein the body portion is formed to surround the first magnetic member by injection molding in a state where the first magnetic member is located inside a die.

6. The water supplier of claim 1,
wherein the second magnetic member is an annular magnet formed along a circumferential direction in order for different poles to alternate with each other.

7. The water supplier of claim 1,
wherein the casing includes:
a water tank which forms a storage space and accommodates the rotor; and
a main body case which accommodates the water tank and forms the control space under the water tank to allow the stator to be accommodated in the control space.

8. The water supplier of claim 7,
wherein the water tank includes:
a base portion;
a rotor accommodation groove extending downwards from the base portion to accommodate the rotor;
a sidewall portion extending from the base portion upwards to a height at which at least a part of the supply unit is immersed in the fluid accommodated therein; and
a support portion extending from an upper end of the sidewall portion in a radial direction and supported by the main body case in a vertical direction.

9. The water supplier of claim 1,
wherein the casing includes:
a water intake plate configured to allow the fluid discharged from the water intake port to flow; and
a water intake container disposed under the water intake plate to close the storage space and including a water recovery port formed to allow at least some of the fluid discharged from the water intake port to move to the storage space.

10. A driving unit for a water supplier disposed in the water supplier and configured to form a flow for supplying fluid, comprising:
a rotor rotatably disposed in a storage space in which the fluid is accommodated inside the water supplier; and
a stator disposed in a control space isolated from the storage space inside the water supplier and configured to transmit electromagnetic force to drive the rotor,
wherein the rotor includes:
a body portion configured to guide the fluid;
a first magnetic member disposed in the body portion; and
a second magnetic member fixed to the body portion by the first magnetic member and configured to receive the electromagnetic force from the stator.
